(19) United States
(12) Patent Application Publication
(10) Pub. No.: US 2013/0250734 A1
(43) Pub. Date: Sep. 26, 2013

(54) Suspendable alarms

(71) Applicant: Arun Kishore Narasani, Los Altos, CA (US)

(72) Inventor: Arun Kishore Narasani, Los Altos, CA (US)

(21) Appl. No.: 13/429,343

(22) Filed: Mar. 24, 2012

(51) Int. Cl. G04G 13/02

(52) U.S. Cl. 368/9

(57) ABSTRACT

Disclosed herein are methods for temporarily disabling alarms by suspending alarms on computing devices for given days or for a specific period of time. The alarms will automatically be re-enabled after the specific period or after the specified days.

### TECHNICAL FIELD

The embodiments herein relate to alarm functionality on computing devices and, more particularly, to suspendable alarms on computing devices.

### BACKGROUND

Alarm clocks are used to produce a sound at a specified time as a reminder. Alarm clocks have evolved from being simple analog alarm clocks that play a sound only once per day to applications on computing devices that allow multiple alarms to be set. These alarms are typically used to awaken people and also to set reminders for specific activities to be done during a day. Today it is common to use any computing device like a laptop, desktop, palm top, mobile phones, phone handsets and so on to have alarm clock functionality either in the form of applications that can be downloaded and installed, or as a native functionality included in the firmware of the device.

Given today's busy lifestyle, people are unable to track the things that they have to do more and more. Alarm clock reminders have become an integral part of people's lives today.

To make it easier for users, alarm clock applications today allow creating alarm reminders and set repeat pattern for the alarm so that users don't have to set an alarm reminder again and again. For example, users are able to set alarm reminders for specific days of week (like Monday, Tuesday, Wednesday and so on). Alarm clock applications also allow users to create alarm reminders for week days, weekends and so on. Such functionality in alarm clock applications save users the effort in remembering to set alarm reminders for standard repeating activities (waking to get kids ready to school, getting ready to office on week days etc.) again and again.

However, when a user has a break from his daily routine due to holidays, or due to the user being on vacation, he may not want the alarm reminders to go off according to standard repeat patterns. For example, let us assume that a user has created an alarm reminder to wake for school time to get his kids ready for school in time. Let us call this the “school alarm”. Usually, users set the alarm reminder for every day of the week (from Monday to Friday) because kids need to go to school every day of the week. Now, if the user has taken off on a Monday or if there is a holiday on a Monday, he would not want the reminder to go off on that particular Monday. With existing alarm clocks, users will have to disable the “school alarm” and re-enable the alarm back after Monday. Given the busy lives, it is possible that users may not always remember to re-enable the alarm after Monday. And that will result in possible delays in getting ready for school on Tuesday.

Therefore, in order to stop reminders for a short period of time, there is a need for alarm reminders to be temporarily disabled for a given period of time or for specific days instead of being completely disabled and manually re-enabled by users.

### BRIEF DESCRIPTION OF THE FIGURES

The embodiments herein will be better understood from the following detailed description with reference to the drawings, in which:

FIG. 1 is a block diagram of an example communication device in the form of a mobile terminal hosting an alarm clock application, according to embodiments herein;

FIG. 2 illustrates the various layers involved in the computing device for running applications, according to embodiments herein;

FIG. 3 illustrates an example alarm clock application on a mobile terminal, according to embodiments herein;

FIG. 4 illustrates the options presented to a user to suspend an alarm for a particular period of time, according to embodiments herein;

FIG. 5 illustrates another way of selecting suspend period to suspend an alarm, according to embodiments herein;

FIG. 6 illustrates a module diagram of an example implementation of some of the features illustrated in FIG. 3, FIG. 4 and FIG. 5, based on user inputs;

FIG. 7 is a flow chart illustrating a preferred way of implementing suspend of alarms, according to embodiments herein;

FIG. 8 is a flow chart illustrating one way of implementing suspension of alarms, according to embodiments herein;

FIG. 9 illustrates the various states that are possible for an alarm while a user's terminal is powered on, according to embodiments herein; and

FIG. 10 illustrates a module diagram of an example implementation of some of the features illustrated and described using FIG. 3, FIG. 4 and FIG. 5, based on the power on event of the terminal.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Existing alarm clocks provide for a facility to disable alarms. So, when a user is on a vacation or has holidays, he may not want to be reminded for day-to-day activities that will not be applicable during vacation or holiday periods. In such instances, with existing alarm clocks, user disables existing alarms either one by one or all at a time (some alarm clocks provide “vacation mode” where all alarms can be disabled with a single click). When the user is back from his vacation or holidays, he will have to remember to re-enable disabled alarms again (either one by one or all together, depending on the alarm clock functionality). If the user does not remember to re-enable one or more alarms, he may be put in an uncomfortable situation due to delays with his day to day activities.

The embodiments herein disclose methods for temporarily disabling alarms by suspending alarms on computing devices for given days or for a specific period of time, where alarms will automatically re-enable themselves after the specific period or after the specified days. The days or periods during which an alarm is suspended can be any time in the future. According to various embodiments, user may configure an alarm to be suspended for specified days or specified period in the future. The computing device will automatically suspend the alarm according to configuration and re-enable after the specified days or periods.

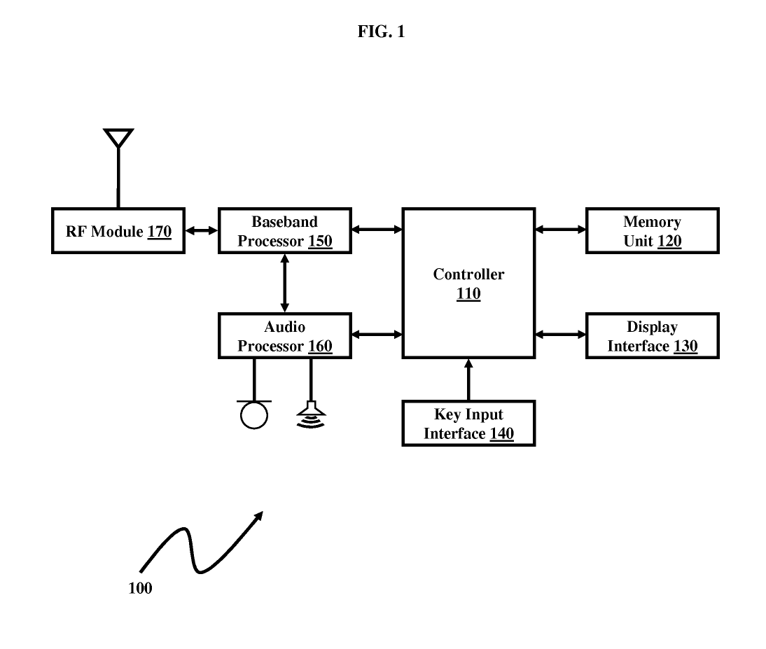

Referring now to the drawings, and more particularly to FIGS. 1 through 10, where similar reference characters denote corresponding features consistently throughout the figures, there are shown embodiments.

Embodiments herein apply to any communication device capable of hosting and running applications either as a native application or as an application delivered through a browser. Examples of suitable communication devices include a laptop, a desktop, palm top, mobile phones, tablets, phone handsets and so on.

FIG. 1 is a block diagram of an example communication device in the form of a mobile terminal 100 that may host an alarm clock application according to embodiments herein. The terminal includes a controller 110, a memory unit 120, a display interface 130, a key input interface 140, a baseband processor 150, an audio processor 160, and a radio frequency (RF) module 170. The controller 110 controls the overall operation of the mobile communication terminal.

The memory unit 120 stores a program for processing and controlling the controller 110, reference data, and various reserved data that can be updated and is provided as a working memory of the controller 110. The memory unit 120 also stores program data relating to an alarm clock application, according to embodiments herein including but not limited to alarm configuration data, and alarm application program information including alarm application layout information.

The display interface 130 provides a display device for users to interact with the applications on the terminal 100. The key input interface 140 may provide various function keys such as a Menu key, a Selection key, a Call key, a Cancel key, an End key, a Volume key, a Photography key, a camera key and so on corresponding to various functions of the terminal and provides key input data corresponding to a key pressed by a user to the controller 110. The key input interface 140 includes character keys that are assigned numbers 0 through 9 and a plurality of English alphabets or another language.

The RF module 170 transmits and receives a radio signal to/from a base station through an antenna. For signal transmission, the RF module 170 modulates a transmission signal input from the controller 110 through the baseband processor 150 into a radio frequency (RF) signal, and transmits the RF signal through the antenna. For signal reception, the RF module 170 demodulates an RF signal received through the antenna and provides the demodulated RF signal to the controller 110. The baseband processor 150 processes a baseband signal transmitted and received between the RF module 170 and the controller 110.

The audio processor 160 connected to the controller 110, processes signal obtained from microphone and speaker interfaces attached to the terminal 100 before passing the signal over to the controller 110 for further processing.

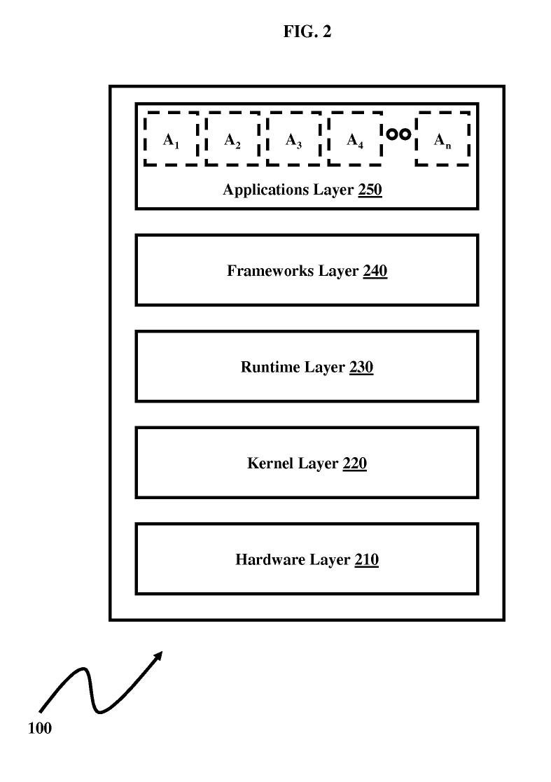

FIG. 2 illustrates the various layers involved in the computing device 100 for running applications according to various embodiments herein. The device 100 comprises of the hardware layer 210 comprising of various hardware elements as illustrated in FIG. 1.

The kernel layer 220 hosts the kernel of the operating system operating in the device 100. Kernel acts as bridge between application processing at the application, application framework and application runtime layers (250, 240 and 230) and the data processing performed at the hardware layer 210. Kernel's responsibilities may include managing device 100 resources (the communication between hardware and software components). As a basic component of an operating system, a kernel can provide the lowest-level abstraction layer for the resources (especially processors and I/O devices) that application software must control to perform its function. Kernel in the kernel layer 220 makes the system resources available to application processes through inter-process communication mechanisms and system calls.

The runtime layer 230 may host relevant libraries for necessary application frameworks in the frameworks layer 240 to function. For example, in the case of an ANDROID mobile communication device, the runtime layer 230 may host a virtual machine to run JAVA programs and programming libraries necessary to support frameworks hosted in the frameworks layer 240 built using the JAVA programming language.

The frameworks layer 240 hosts the necessary frameworks to be able to run applications on the device 100. For example, in the case of an ANDROID mobile communication device, the framework layer 240 hosts the ANDROID application framework to be able to develop applications for an ANDROID device. The application frameworks layer 240 may include programs that manage the phone's basic functions like resource allocation, telephone applications, switching between processes or programs and keeping track of the phone's physical location among many others. The application frameworks layer 240 may further include necessary abstract functions built on top of a programming language like JAVA to provide more complex and rich functionality specific to the ANDROID device 100. Having access to the device resources and to functionality through a language like JAVA allows developers to develop applications to be hosted on the applications layer 250.

The applications layer 250 hosts a plurality of applications built on top of the frameworks provided by the computing device 100 through the frameworks layer 240. In a preferred embodiment, embodiments herein may be realized by downloading, installing, and running an alarm clock application on the device 100. However, an ordinarily skilled person may realize that the methods and mechanisms disclosed herein to achieve suspend functionality for alarms may be provided as a functionality of the framework on the device 100, or as a feature in the underlying programming language, or as a feature in the libraries built on top of the programming language hosted in the runtime layer 230.

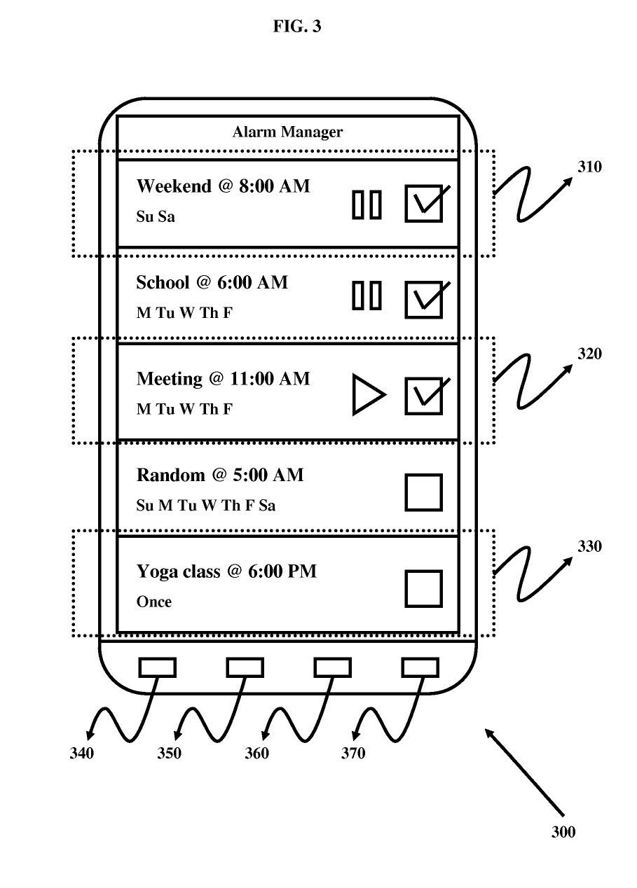

FIG. 3 illustrates an example alarm clock application on a mobile terminal, according to embodiments herein. FIG. 3 shows the alarm manager screen of the alarm clock application that lists available alarms created by the user. When an alarm is created, in a preferred embodiment, the alarm is enabled and active. The checkbox associated with each alarm indicates whether the alarm is enabled or disabled. An enabled alarm will have the checkbox in checked status and a disabled alarm will have its checkbox in unchecked status. Enabled alarms will have an additional indicator to show whether the alarm is in active state or not. An active alarm is an alarm that is enabled, and it not suspended. A suspended alarm is an alarm that is enabled, but is suspended based on user configuration. A suspended alarm is different from a disabled alarm. A disabled alarm must be enabled manually by the user to be come active when he is chooses to re-enable the alarm, whereas a suspended alarm will be active automatically after the suspend period is over.

In FIG. 3, the alarms named “Weekend” and “School” is both enabled and are currently active. The fact that the alarms are enabled is shown by the fact that the checkboxes are in checked state, as indicated by the “Weekend” alarm 310. The fact that the alarms are active is indicated by the pause button next to the checkbox.

When a user chooses to suspend an alarm, for example “School” alarm, for a particular period, he may click on the pause button next to the checkbox relevant to the alarm. The mobile terminal will present options to choose the period for which the user chooses to suspend the alarm. Upon choosing period, the alarm will be moved to suspended state. When an alarm is in suspended state, the alarm will indicate that using a play button next to the checkbox replacing the pause button as indicated by the alarm “Meeting” 320. In this example illustrated by FIG. 3, the alarm “Meeting” 320 is in a paused state. It is possible that a user has a daily meeting at his office and that the daily meeting may have been cancelled temporarily for a few days because many of his colleagues may be off to a conference out of town. So the user has suspended the alarm for a specified period of time. When the time period for which the meeting is cancelled elapses, the system will automatically makes the alarm active by invoking unsuspend (or resume) action on the alarm.

When an alarm is disabled, the alarm may present itself like the alarm 330 in the illustration. In a preferred embodiment, a disabled alarm may not present any options to suspend as that alarm is not relevant in present times to the user.

Buttons (340, 350, 360, and 370) represent a set of keys that may match to context sensitive functions based on the screen viewed by the user or fixed functions. The buttons may be physical buttons, capacitive buttons reacting to touch or soft buttons integrated within the display. In an example embodiment, button 340 may be a button that would take a user to home screen of the terminal, button 350 may be a button to show context menu sensitive menu based on the screen being viewed, button 360 may be a button to back to previous screen, and button 370 may be a button to search for content (data, applications, contacts and so on) on the terminal.

Upon clicking on the button 340, the user may be presented with many options relevant to the alarm clock application. In particular, the user may be presented with an option to suspend all alarms together for a particular period of time. Further, user may also be presented context sensitive menu for a particular alarm based on a pre-defined gesture like a long click on the alarm. So, for example, when a user performs a long click action on the alarm, the application the may present many options specific to the alarm on which the user clicked. The user may be presented with options such as deleting the alarm, enabling the alarm is the alarm is disabled, disabling the alarm if alarm is enabled, suspending the alarm if alarm is active, and activating the alarm is alarm is suspended and so on. Therefore, user can have options to suspend either individual alarm separately by accessing alarm specific context sensitive menu or suspend all active alarms together using a screen specific context sensitive menu.

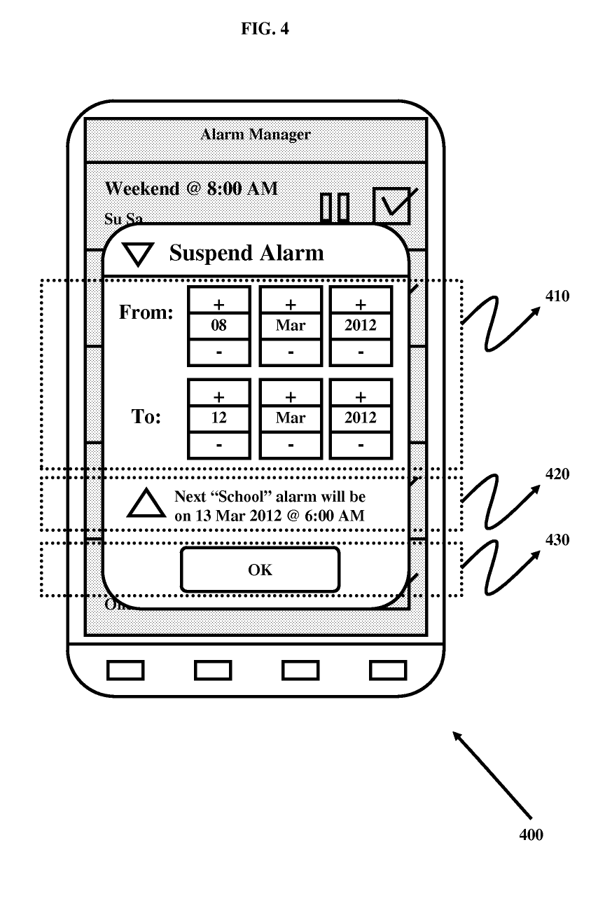

FIG. 4 illustrates the options presented to a user to suspend an alarm for a particular period of time, according to embodiments herein. User arrives at this screen by choosing a context sensitive menu to suspend a specific alarm (“School” alarm in this example). In the example being illustrated, user can choose to suspend an alarm (“School” alarm, for example) for a period time by specifying start date and end date 410 of the period. In a preferred embodiment, the start date will be date on which the user chooses to suspend the alarm. Therefore, if the user chooses to suspend from current date, he only needs to choose the end date to specify the period for which the user intends to suspend the alarm. Upon selecting the end date, the application may display the next alarm date 420 for the alarm after suspension period, irrespective of whether the alarm is suspended from the current date or from a future starting date. The next alarm date after suspension will take into any repeat options selected for the alarm. For example, a typical “School” alarm will be set to repeat through the work week (from Monday to Friday). Therefore, in an example, if the alarm is suspended for a Thursday and a Friday, then the next alarm date will be shown as the next Monday as the alarm is not set to repeat during Saturdays and Sundays. However, in a preferred embodiment, the alarm may be returned to active state after suspension period on Saturday.

In various other embodiments, user may also be presented options to choose the suspension period by way of keying in number of days, weeks or months for which an alarm is to be suspended from either a chosen start date or from the date of user input. When there is no start date provided by user, the suspended state may automatically start from current date and the end date of suspended state may be calculated based on the time period entered.

After the choosing the period either by way of specifying number of days or by way of selecting start and end dates, user may confirm his choice to suspend an alarm by clicking on button 430.

In various other embodiments, user may also choose to suspend all alarms together for a specified period (either by way of selecting days or dates) using similar options.

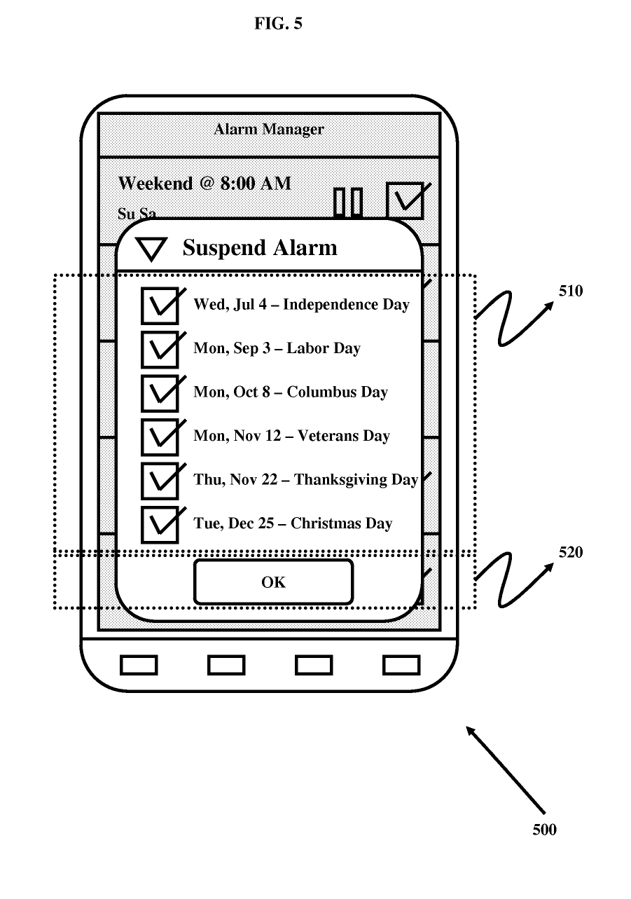

FIG. 5 illustrates another way of selecting suspend period to suspend an alarm, according to embodiments herein. Apart from choosing a period, the alarm clock application may also present an option to a user to suspend individual alarms or all alarms based on a calendar of holidays specific/relevant to the region in which the user resides. The alarm clock may have a pre-defined holiday calendar attached to it based on which the application presents a list of holidays on which the user can suspend one or more alarms. In a preferred embodiment, when the user installs the application, the application may present with a number of holiday calendars, and the user may choose one or more holiday calendars based on the area or region (city, state, country and so on) in which he resides in. The alarm clock application stores user preferences on the holiday calendars. Further, the user may choose to suspend alarm specifically on selected holidays. The holidays presented to the user may be based on the calendars chosen by the user.

In various embodiments, the user may be able to choose to suspend an individual alarm on selected holidays from a list of holidays 510 presented to the user. In various other embodiments, the user may be able to choose to suspend all alarms on selected holidays from a list of holidays 510 presented to the user.

In some other embodiments, user may also attach a personal calendar as a holiday calendar and provide configuration information to choose holidays from the attached calendar. The alarm clock application may choose holidays based on specified tags, keywords, labels, type of event and so on. The attached calendar could be a public calendar of the user, a public calendar of another user, a private calendar of the user with credentials, or a private calendar of his friend or a family member. For example, it is possible to access popular calendar systems from GOOGLE and YAHOO using their APIs by providing relevant authentication and authorization information. The calendar information may be obtained by connecting to the relevant system using appropriate APIs and using appropriate authentication and authorization mechanisms.

In various embodiments, user can configure the alarm clock application to present the list of days to suspend based on his vacation preferences (and not necessarily holidays). For example, when attaching a private calendar, he may provide keywords or tags or labels to identify events relevant to vacation events and not holiday events. Thereby, the user can potentially attaching any kind of days (vacation, holidays, family reunion days, and so on) to be presented in his list of days of suspending an individual alarm or all active alarms together.

Upon selecting one or days from a list of holidays or calendar days, the user may confirm his choice by clicking a button 520 to suspend one or more alarms on specified days.

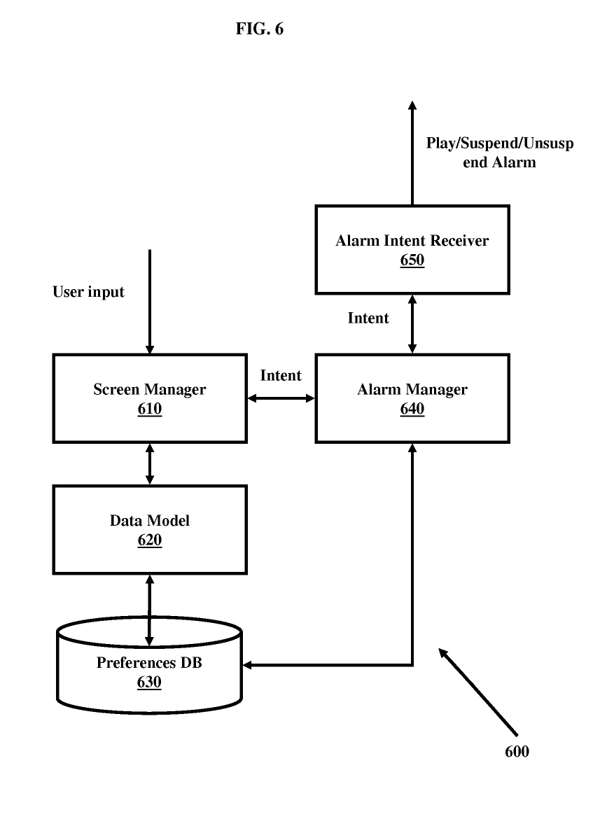

FIG. 6 illustrates a module diagram of an example implementation of some of the features illustrated and described using FIG. 3, FIG. 4 and FIG. 5, based on user inputs. An example implementation of preferred embodiments may include a screen manager 610 to provide necessary user interface elements on the terminal for the user to interact with, a data model 620 to carry information provided by user to be stored in preferences database 630 and retrieving data from preferences database 630 to display to user the, a preferences database 630 to store user preferences, an alarm manager 640 to manage various alarm intents, and an alarm intent receiver 650 to receive necessary call back from alarm manager 640 when it is time for the intent to be performed. Intent is an abstract representation of an action to be performed, either instantly or in future.

In various embodiments, intents may be used as bridging agents between multiple modules to pass on information and to make necessary call backs to registered receivers. In the example implementation, intents are used to represent alarm related actions to be performed.

Based on user input or an intent performed, an intent may be created for a new alarm, to suspend an existing alarm, to unsuspend a suspended alarm and so on. The creation of an intent may be performed by the screen manager 610 or any other sub module. The intent created may be passed on to the alarm manager to call necessary call back function to a registered intent receiver like the alarm intent receiver 650. When it is time for the intent to be performed, the alarm manager 640 passes on the intent to alarm intent receiver 650. The alarm intent receiver 650 receives the intent to be performed from the alarm manager 640 and performs the necessary action based on the intent received.

In a preferred embodiment, at the time of creation of intent, the alarm intent receiver 650 is registered to perform a specific function. For example, there may be different receivers configured for different functions including but not limited to playing an alarm, suspending an active alarm, unsuspending (or resume) a suspended alarm, among others. Depending on the user input or action performed, the screen manager 620 or another suitable module can create an intent and set the appropriate receive to perform the necessary function. For example, is a user chooses to suspend an active alarm, the screen manager 620 can create an intent to suspend the alarm along with necessary information like identifying information about the alarm, suspend dates, suspend days suspend start date, and suspend end date. Upon creating the intent, the screen manager 620 can also attach necessary receiver to the intent to perform the action of suspending the alarm identified alarm when it is time for the alarm to be suspended. Upon successfully creating the intent and attaching the receiver, the screen manager 620 hands over the intent to the alarm manager 640 with necessary configuration information like time at which the intent is to be performed. The alarm manager monitors 640 the time and calls the intent receiver registered with the intent when it is time to perform the intent. Upon receiving the call back from the screen manager 640, the intent receiver registered with the intent performs the necessary function.

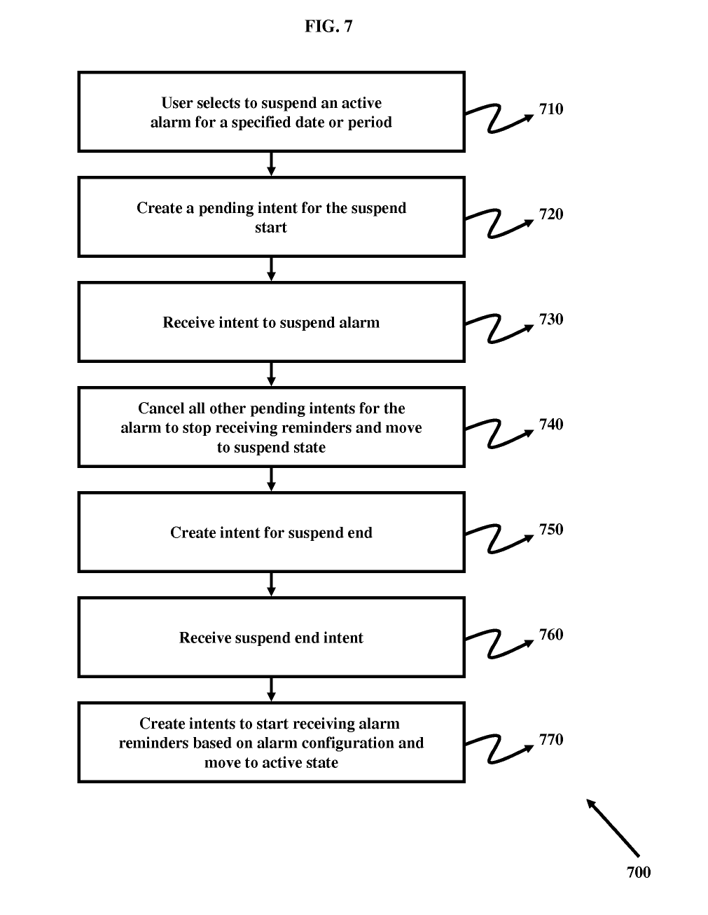

FIG. 7 is a flow chart illustrating a preferred way of implementing suspend of alarms, according to embodiments herein. When a user selects (710) to suspend an active alarm, the screen manager 620 stores the preferences in the database and creates (720) necessary intent for the event “suspend start”. That would be intent that will move an active alarm to “suspend” state. Upon creating the intent and attaching necessary receiver, the screen manager 620 can pass the intent to the alarm manager 640. When the receiver receives (730) the intent to be performed through a call back from the alarm manager 640 when it is time for the intent to be performed, the receiver cancels (740) all other pending intent for the particular alarm for which the suspend intent was created to stop any reminders during the suspend period. Subsequently, the receiver moves the alarm to “suspend” state. Once the alarm is moved to “suspend” state, the receiver further creates (750) another intent for the event “suspend end”, attaches an appropriate intent receives to perform the event “suspend end” and passes the intent to the alarm manager 640 to take necessary action when it is time to end the suspend period. When it is time to end the suspend period, the alarm manager 640 passes on the intent to end suspend period to the receiver registered. The receiver registered to the intent to end suspend period, receives (760) the intent. Further, the intent receiver to end suspend period creates (770) new intents for receiving alarm reminders and moves (770) the alarm to “active” state.

The various actions in method 700 may be performed in the order presented, in a different order or simultaneously. Further, in some embodiments, some actions listed in FIG. 7 may be omitted.

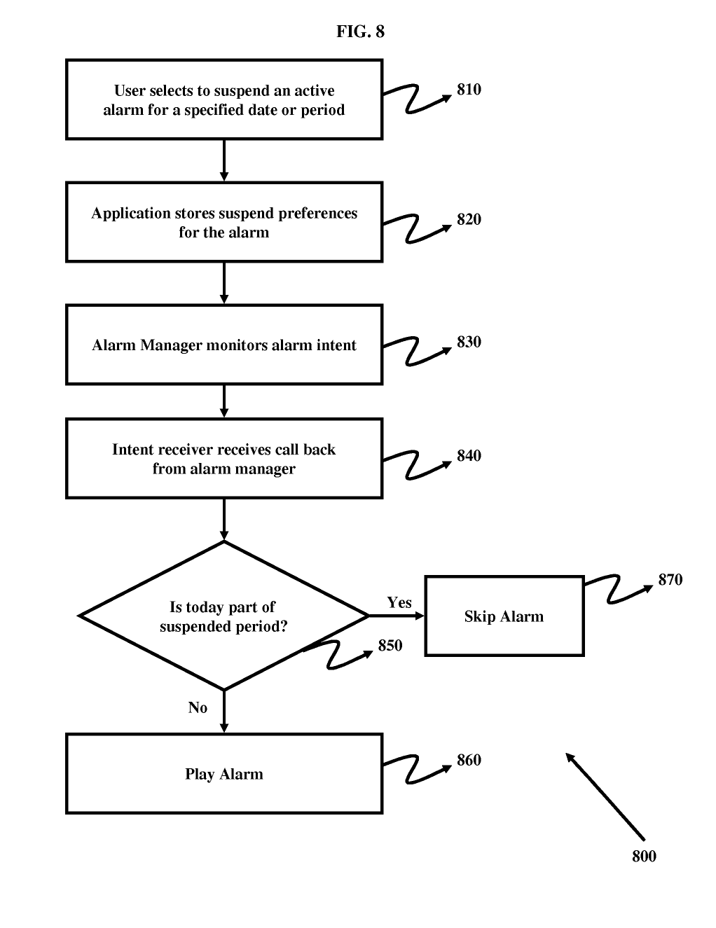

FIG. 8 is a flow chart illustrating one way of implementing suspension of alarms, according to embodiments herein. When a user selects to suspend (810) an active alarm for a specified date or period (either using dates or days), the screen manager 620 stores (820) the preferences of the user in the preferences database 630. In this embodiment the screen manager 620 does not create an intent specifically for suspending the alarm. The screen manager 620 originally would have handed over the intent to play an alarm to the alarm manager 640 according to the alarm configuration. The alarm manager 640 monitors (830) the intent and when it is time for the intent to be performed, the alarm manager makes necessary call back to the receiver registered with the intent to play the alarm. The intent receiver receives (840) the call back and checks if the alarm is in a suspend mode for that period by checking (850) if the time at which the alarm is to be played is within the suspend period configured by the user before playing the alarm. If the time is within the period, then the alarm would not play (or skip the alarm) (870). And, if the time is outside the period of suspend, the intent receiver would play (860) the alarm.

The various actions in method 800 may be performed in the order presented, in a different order or simultaneously. Further, in some embodiments, some actions listed in FIG. 8 may be omitted.

The implementation illustrated in FIG. 7 is more advantageous for the reason that alarm reminder intents need not be called during suspend period. For example, when a user suspends a “work” alarm for 3 weeks, the alarm reminder intents need not be called during the suspend period of the 3 weeks. The implementation illustrated in FIG. 7 ensures to avoid unnecessary firing of intent reminder receiver to play alarms by creating one intent for starting suspend status and another intent for ending suspend status.

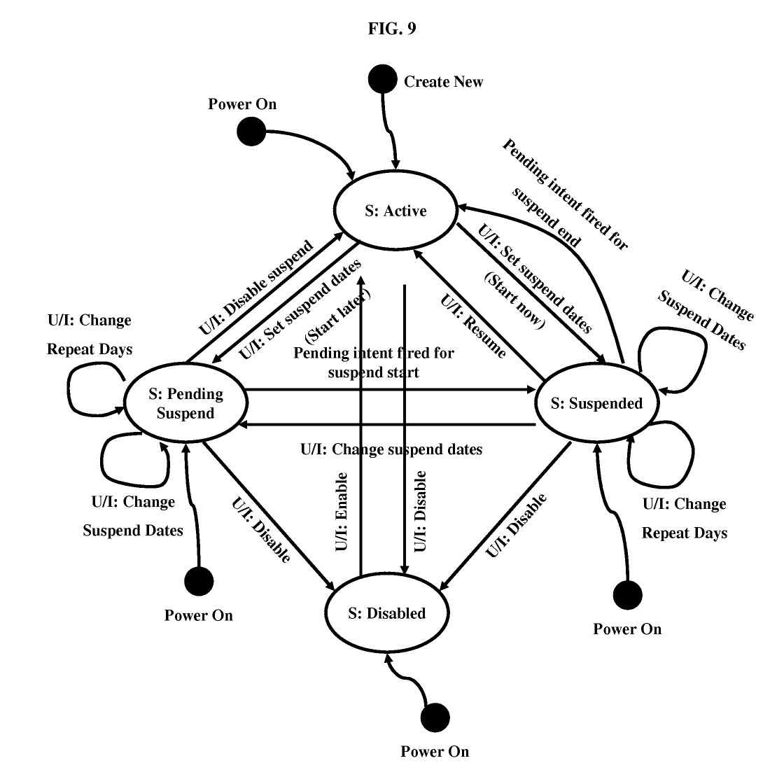

FIG. 7 and FIG. 8 illustrate how a suspending of alarm may be done. For brevity, FIG. 7 and FIG. 8 focused on the simple flow of suspending an alarm and unsuspending (or resuming) an alarm. However, in reality, a user's interaction with a system like an alarm clock can be more complex. It is possible that a user suspends an alarm, then decides to unsuspend it before the suspend period is active. It is also possible that the terminal is powered off or restarted. It is also possible that the user disables an alarm that is in suspend state and so on. FIG. 9 illustrates the various states that are possible for an alarm while a user's terminal is powered on, according to embodiments herein. The possible states are: Active, Suspend, Disabled, Pending Suspend. In FIG. 9, some actions are labeled with the text “U/I” to represent an action performed as a result of user input (U/I). The possible and non-exhaustive list of actions that can be performed in each of these states and the resulting state due to the action performed are discussed below:
State: Active
   Active state represents that an alarm is enabled and is active to receive alarm reminders. The major actions that can occur in the state are:
   U/I: Set suspend dates (Start date is immediate)
      This is a user input to suspend an alarm immediately by configuring suspend dates (either by way of selecting dates or providing number of days for which to suspend, or by selecting specific pre-configured days like holidays and so on). The alarm clock system cancels all pending intents for playing alarm reminders and creates a new intent for suspend end event. The resulting state will be “suspended” as the suspend state starts immediately.
   U/I: Set suspend dates (Start date is at a later time)
      This is a user input to suspend an alarm starting at a future date by configuring suspend dates (either by way of selecting dates or providing number of days for which to suspend, or by selecting specific pre-configured days like holidays and so on). The alarm clock system creates a new intent for suspend start event. The resulting state will be “pending suspend” as suspend state starts in future.
   U/I: Disable
      This is action performed by user to disable an active alarm. The alarm clock system cancels all pending intents for playing alarm reminders. The resulting state will be “disabled”.
State: Suspended
   Suspended state represents that an alarm is enabled and but is not receiving alarm reminders for a temporary period of time. The major actions that can occur in the state are:
   U/I: Resume
      This is a user input to resume a suspended action. The alarm clock system cancels the intent for suspend end event. Further, the alarm clock system creates necessary intents for alarm reminders based on alarm configuration. The resulting state will be “active”.
   U/I: Change suspend dates
      This is a user input to change suspend dates when the time of change is not within new suspend period any more. When the time of change of dates is not within, the alarm is moved to “pending suspend” state. Before changing the state of the alarm, the alarm clock system cancels the intent for suspend end event, and creates necessary intents for alarm reminders, and an intent for suspend start event.
   U/I: Disable
      This is a user input to disable an alarm. The alarm clock system cancels the intent for suspend end event. The alarm is moved to “disabled” state.
   U/I: Change repeat days
      This is a user input to change repeat days of the alarm. The change in repeat days are noted, and the necessary intents may be created depending on when suspend period ends. However, until suspend end intent is fired, the alarm remains in the “suspended” state.
   U/I: Change suspend dates
      This is a user input to change suspend dates when the time of change of dates is within the new suspend period. When the time of change of dates is within, the alarm remains in “suspended” state till suspend end intent is fired. The alarm clock system cancels the existing intent for suspend end event, and recreates another intent for suspend end event when the suspend end date changes.
   Fire pending intent to end suspend period
      When a pending suspend end intent is fired, the alarm will move to active state. Before change of state to active state, the system creates new intents for alarm reminders based on alarm configuration.
State: Disabled
   Disabled state represents that an alarm is not enabled. The major actions that can occur in the state are:
   U/I: Enable
      This is a user input to enable a disabled alarm. The alarm clock system creates necessary intents for alarm reminders based on alarm configuration. The alarm moves to “active” state.
State: Pending suspend
   Pending suspend state represents that an alarm is enabled and is active to receive alarm reminders. However, the alarm has a pending intent that will move the alarm to suspended state. The major actions that can occur in the state are:
   U/I: Disable suspend intent
      This is a user input by way of changing suspend days or dates or canceling a suspend intent. User may perform this by entering 0 days as suspend period or “cancel” a pending suspend intent in alarm specific context menu. In a preferred embodiment, the alarm specific context menu may show an option to cancel a pending suspend intent. The alarm is moved “active” state. Before the change of state, the alarm clock system cancels the pending intent for suspend start event and creates new intents for alarm reminders.
   Fire pending intent for suspend
      When a pending suspend intent is fired, the alarm is moved to “suspended” state. A pending suspend intent is fired when it is time for start of the suspend period. Before the change of state, the alarm clock system creates an intent for suspend end event based on the suspend end date and also cancels alarm reminder events.
   U/I: Disable
      This is a user input to disable an alarm. The alarm is moved to “disabled” state. Before change of state of the alarm, the alarm clock system cancels of pending intents.
   U/I: Change repeat days
      This is a user input to change repeat days of the alarm. The change in repeat days are noted, and the necessary intents may be created depending on when suspend period starts and when suspend period ends. However, until suspend start intent is fired, the alarm remains in the “pending suspend” state. Based on change in repeat days, the alarm clock system may cancel some of the existing pending intents for alarm reminders, and create new intents for alarm reminders.
   U/I: Change suspend dates
      This is a user input to change suspend dates when the time of change is outside new suspend period. When the time of change of dates is outside, the alarm remains in “pending suspend” state till suspend start intent is fired. However, if the suspend period start date is changed, then the pending intent for suspend start event is cancelled and a new intent for suspend start event is created based on the new suspend period start date.
   U/I: Change suspend dates
      This is a user input to change suspend dates when the time of change is within new suspend period. When the time of change of dates is within the suspend period, the alarm is moved to “suspended” state. The alarm clock system cancels all pending intents, and create a new intent for suspend end event before the change of state.

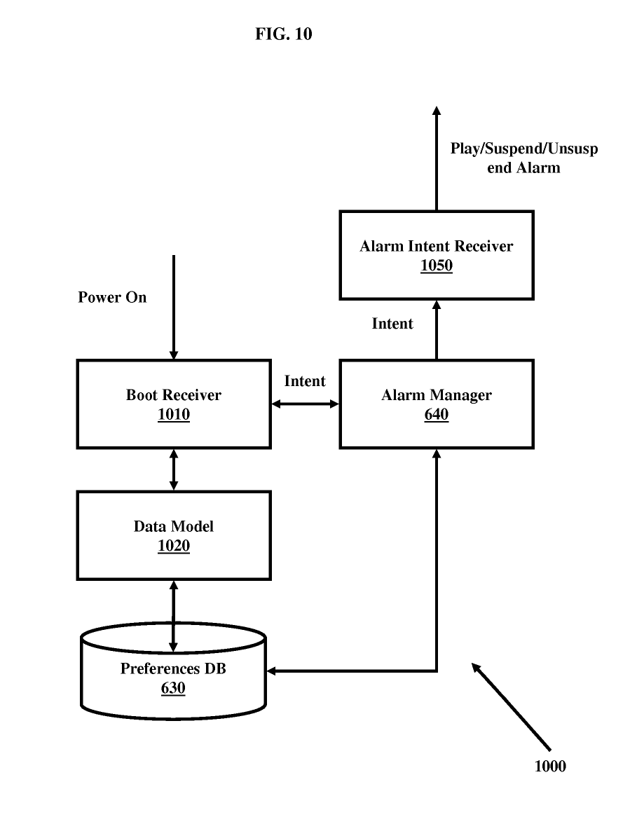

FIG. 10 illustrates a module diagram of an example implementation of some of the features illustrated and described using FIG. 3, FIG. 4 and FIG. 5, based on the power on event of the terminal.

An example implementation of preferred embodiments may include a boot received 1010 to receive call back at the time of power on event to take necessary actions to resume the alarm clock application to its original state before the terminal was powered off. The boot receiver may obtain necessary information about alarms from the preferences database 630 using a data model 1020, and creates necessary intents based on the state of the various alarms stored in the database 630. The intents created are attached to appropriate receivers based on the state of individual alarms, and the intents are passed on to the alarm manager 640 to monitor the intents to be fired. The alarm manager in turn monitors the intents and fires the intents by calling receivers attached to intents like the alarm intent receiver 1050 to take necessary action.

In other embodiments, an API interface may be provided to create suspendable pending intents, where you can create pending intents based on settings of an alarm and set it's suspend start and end dates. This can be provided as part of the framework that allows scheduling pending intents. In an embodiment, an API may be provided within the framework layer 240 or the runtime layer 230 to create intents that may be suspendable and pending accordingly. Such an API may obviate the need to cancel and create intents in some instances during state changes.

The embodiments disclosed herein can be implemented through at least one software program running on at least one hardware device and performing network management functions to control the network elements. The elements shown in FIG. 1 and FIG. 2 include blocks which can be at least one of a hardware device, or a combination of hardware and software modules.

The embodiments disclosed herein disclose methods and devices providing mechanisms to temporarily disable alarm reminders configured in an alarm clock application by allowing users to suspend specified alarms for specified days or for a specified period of time. Therefore, it is understood that the scope of the protection is extended to such a program and in addition to a computer readable means having a message therein, such computer readable storage means contain program code means for implementation of one or more steps of the method, when the program runs on a mobile device or any suitable programmable computing device. The computing device can be any kind of device which can be programmed including e.g. a personal computer, or mobile communication devices like a laptop, a mobile device, a tablet, a palm top any combination thereof. The computing device may be a single processor device or a multi-processor device, e.g. one processor and two FPGAs. The device may also include means which could be hardware means like an ASIC, or a combination of hardware and software means like an ASIC and an FPGA, or at least one microprocessor and at least one memory with software modules located therein. The method embodiments described herein could be implemented in pure hardware or partly in hardware and partly in software.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for suspending an alarm on a computing device, said method comprising:
obtaining input to suspend an alarm, wherein said input comprises a suspend period;
when said suspend period starts in a future date
creating a pending intent for suspend start event, and
moving said alarm to pending suspend state; and
when said suspend period starts immediately
canceling all intents relating to said alarm,
creating an intent for suspend end event arising at the end of said suspend period, and
moving said alarm to suspended state.

2. The method as in claim 1, wherein said suspend period may be obtained as start date and end date through user input.

3. The method as in claim 1, wherein said suspend period may be obtained as days of suspend period from the date of user input.

4. The method as in claim 1, wherein said suspend period may be obtained as days of suspend period and a start date provided through user input.

5. The method as in claim 1, wherein said suspend period may be obtained from an attached calendar.

6. The method as in claim 1, wherein said method comprising
receiving user input to resume said alarm, when said alarm is in suspend state;
canceling pending intent to end suspend state at the end of said suspend period;
creating one or more intents for alarm reminders based on configuration of said alarm; and
moving said alarm to active state.

7. The method as in claim 1, wherein said method comprising
receiving suspend period end event, when said alarm is in suspend state;
creating one or more intents for alarm reminders based on configuration of said alarm; and
moving said alarm to active state.

8. The method as in claim 1, wherein said method comprising
receiving user input to modify said suspend period to a new suspend period, when said alarm is in suspend state and where date of user input to modify said suspend period falls outside the said new suspend period;
canceling pending intent to end suspend state at the end of said suspend period;
creating one or more intents for alarm reminders based on configuration of said alarm;
creating pending intent to start suspend state at the start of said new suspend period; and
moving said alarm to pending suspend state, when suspend start date of said new suspend period is later than the date of user input to modify said suspend period.

9. The method as in claim 1, wherein said method comprising
receiving user input to disable said alarm, when said alarm is in suspend state;
canceling pending intent to end suspend state at the end of said suspend period; and
moving said alarm to disabled state.

10. The method as in claim 1, wherein said method comprising
receiving user input to modify said suspend period to a new suspend period, when said alarm is in suspend state and where date of user input to modify said suspend period falls within the said new suspend period;
canceling pending intent to end suspend state at the end of said suspend period; and
creating an intent to end suspend state at the end of said new suspend period.

11. A method for suspending an alarm on a computing device, said method comprising:
obtaining user input to suspend an alarm, wherein said input comprises a suspend period;
comparing time of alarm before playing an alarm if said time is within said suspend period; and
playing alarm reminder only if said time of alarm is outside said suspend period.

12. An alarm clock apparatus embodied in a computing device comprising
a means for receiving user input to suspend an alarm, where said input comprises a suspend period.

13. An alarm clock apparatus embodied in a computing device configured to perform a method for suspending an alarm on a computing device, said method comprising:
obtaining input to suspend an alarm, wherein said input comprises a suspend period;
when said suspend period starts in a future date
creating a pending intent to suspend, and
moving said alarm to suspend state upon receiving suspend start event; and
when said suspend period starts immediately
canceling all intents relating to said alarm,
creating an intent to end suspend state at the end of said suspend period, and
moving said alarm to suspend state upon receiving suspend start event.

14. The apparatus as in claim 13, wherein said suspend period may be obtained as start date and end date

15. The apparatus as in claim 13, wherein said suspend period may be obtained as days of suspend period, where start date is assumed to the date of intent.

16. The apparatus as in claim 13, wherein said suspend period may be obtained as days of suspend period and a start date provided through user input.

17. The apparatus as in claim 13, wherein said suspend period may be obtained from an attached calendar.

18. The apparatus as in claim 13, wherein said method comprising
receiving user input to resume said alarm, when said alarm is in suspend state;
canceling pending intent to end suspend state at the end of said suspend period;
creating one or more intents for alarm reminders based on configuration of said alarm; and
moving said alarm to active state.

19. The apparatus as in claim 13, wherein said method comprising
receiving suspend period end event, when said alarm is in suspend state;
creating one or more intents for alarm reminders based on configuration of said alarm; and
moving said alarm to active state.

20. The apparatus as in claim 13, wherein said method comprising
receiving user input to modify said suspend period to a new suspend period, when said alarm is in suspend state and where date of user input to modify said suspend period falls outside the said new suspend period;
canceling pending intent to end suspend state at the end of said suspend period;
creating one or more intents for alarm reminders based on configuration of said alarm;
creating pending intent to start suspend state at the start of said new suspend period; and
moving said alarm to pending suspend state, when suspend start date of said new suspend period is later than the date of user input to modify said suspend period.

21. The apparatus as in claim 13, wherein said method comprising
receiving user input to disable said alarm, when said alarm is in suspend state;
canceling pending intent to end suspend state at the end of said suspend period; and
moving said alarm to disabled state.

22. The apparatus as in claim 13, wherein said method comprising
receiving user input to modify said suspend period to a new suspend period, when said alarm is in suspend state and where date of user input to modify said suspend period falls within the said new suspend period;
canceling pending intent to end suspend state at the end of said suspend period; and
creating an intent to end suspend state at the end of said new suspend period.
